(19) United States
(12) Patent Application Publication
(10) Pub. No.: US 2016/0266528 A1
(43) Pub. Date: Sep. 15, 2016

(54) HEATER, FIXING UNIT, AND IMAGE FORMING APPARATUS

(71) Applicant: FUJI XEROX CO., LTD., Tokyo (JP)

(72) Inventor: Mikio SAIKI, Kanagawa (JP)

(73) Assignee: FUJI XEROX CO., LTD., Tokyo (JP)

(21) Appl. No.: 14/829,005

(22) Filed: Aug. 18, 2015

(30) Foreign Application Priority Data
Mar. 9, 2015 (JP) 2015-045470

(51) Int. Cl. G03G 15/20; H05B 3/06; H05B 3/00

(52) U.S. Cl. CPC G03G 15/2053; H05B 3/0014; H05B 3/06

(57) ABSTRACT

A heater includes a heating element that includes an electrode disposed at an end of the heating element in a longitudinal direction of the heating element and that generates heat as a result of power being supplied to the heating element via the electrode, a support member that supports the heating element, a connecting member that is disposed between the heating element and the support member and that couples the heating element and the support member to each other at the end, the connecting member being fixed to the heating element in directions including the longitudinal direction and being fixed to the support member in such a manner as to be freely movable in the longitudinal direction, and a wiring line that is connected to the electrode of the heating element and fixed to the connecting member.

### CROSS-REFERENCE TO RELATED APPLICATIONS

This application is based on and claims priority under 35 USC 119 from Japanese Patent Application No. 2015-045470 filed Mar. 9, 2015.

### BACKGROUND

(i) Technical Field

The present invention relates to a heater, a fixing unit, and an image forming apparatus.

(ii) Related Art

In the related art, an image fixing device is known that heats an image on a recording medium by using a fixing unit, which includes a heating element, and fixes the image onto the recording medium, and this heating element thermally expands when generating heat.

### SUMMARY

According to an aspect of the invention, there is provided a heater including a heating element that includes an electrode disposed at an end of the heating element in a longitudinal direction of the heating element and that generates heat as a result of power being supplied to the heating element via the electrode, a support member that supports the heating element, a connecting member that is disposed between the heating element and the support member and that couples the heating element and the support member to each other at the end, the connecting member being fixed to the heating element in directions including the longitudinal direction and being fixed to the support member in such a manner as to be freely movable in the longitudinal direction, and a wiring line that is connected to the electrode of the heating element and fixed to the connecting member.

### BRIEF DESCRIPTION OF THE DRAWINGS

Exemplary embodiments of the present invention will be described in detail based on the following figures, wherein:

FIG. 1 is a schematic diagram briefly illustrating a configuration of a printer, which is an image forming apparatus according a first exemplary embodiment of to the present invention;

FIG. 2 is a cross-sectional view of a fixing unit;

FIG. 3 is a diagram illustrating an accommodating unit that is accommodated in a heating roller;

FIG. 4 is a diagram illustrating the state of a wiring connection using a connector;

FIG. 5 is a diagram schematically illustrating a wiring structure of a heater in a comparative example;

FIG. 6 is a diagram schematically illustrating a wiring structure of a heater according to the exemplary embodiment;

FIG. 7 is an exploded perspective view of the accommodating unit;

FIG. 8 is a cross-sectional view of the heating roller;

FIG. 9 is an exploded perspective view of a heater portion;

FIG. 10 is a sectional view illustrating a structure around the periphery of a retainer;

FIG. 11 is a perspective view illustrating the structure around the periphery of the retainer; and

FIG. 12 is a diagram illustrating a connector structure according to a second exemplary embodiment.

### DETAILED DESCRIPTION

Exemplary embodiments of the present invention will be described below with reference to the drawings.

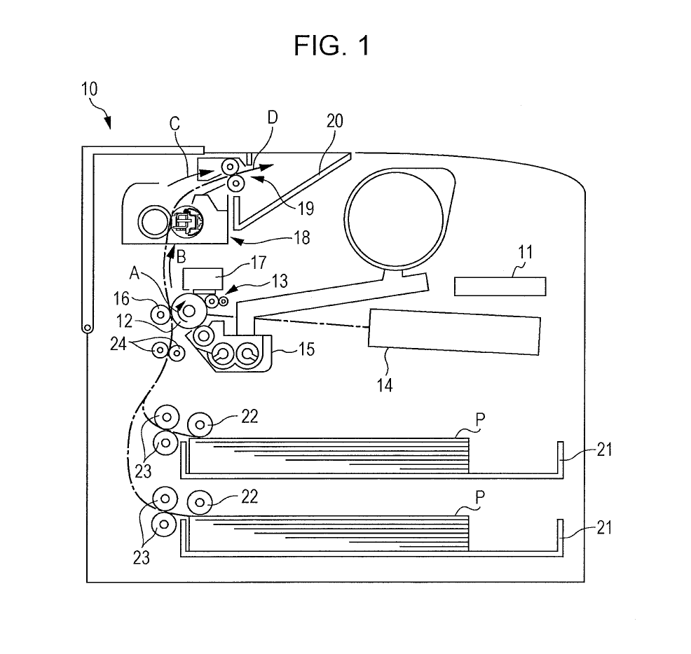

FIG. 1 is a schematic diagram briefly illustrating a configuration of a printer, which is an image forming apparatus according to a first exemplary embodiment of the present invention.

A printer 10 illustrated in FIG. 1 is a black-and-white printer, and an image signal, which represents an image and which is formed outside the printer 10, is to be input to the printer 10 via a signal cable or the like (not illustrated). The printer 10 includes a controller 11 that controls the operation of each component of the printer 10, and the image signal is to be input to the controller 11. The printer 10 performs image formation based on the image signal under control of the controller 11.

Sheet trays 21 are disposed in a lower portion of the printer 10, and sheets P are accommodated in the sheet trays 21 in such a manner as to be stacked on top of one another. The sheet trays 21 are configured to be capable of being drawn out to be supplied with the sheets P. There is a case where the size of each of the sheets P accommodated in the sheet trays 21 is changed by a user, and in addition, there is a case where the sheets P having different sizes are accommodated in the plural sheet trays 21. Since the controller 11 recognizes the sizes of the sheets P that are actually accommodated in the sheet trays 21 and uses the information regarding the sizes for controlling each unit of the printer 10, a mechanism of automatic recognition using a sensor or the like or a mechanism of recognition in accordance with an input from a user or the like is incorporated within the printer 10.

Instead of the sheets P, which are paper sheets, OHP sheets, plastic sheets, envelopes, and the like may be accommodated in the sheet trays 21 as recording media of the exemplary embodiment of the present invention. Although operation of the printer 10 will now be described with reference to FIG. 1, which illustrates the case where the sheets P are accommodated in the sheet trays 21, the basic operation of the printer 10 is common to the case where other recording media are accommodated in the sheet trays 21.

One of the sheets P in the sheet trays 21 is delivered to standby rollers 24 by a pickup roller 22 and separation rollers 23. The timing of transportation of the sheet P, which has reached the standby rollers 24, is adjusted, and the sheet P is further transported.

The printer 10 includes a photoconductor 12 that has a columnar shape and rotates in the direction of arrow A, and a charger 13, an exposure unit 14, a developing unit 15, a transfer unit 16, and a photoconductor cleaner 17 are disposed around the photoconductor 12. A combination of the photoconductor 12, the charger 13, the exposure unit 14, the developing unit 15, and the transfer unit 16 corresponds to an example of a forming unit according to the exemplary embodiment of the present invention.

The charger 13 charges a surface of the photoconductor 12, and the exposure unit 14 exposes the surface of the photoconductor 12 to light in accordance with an image signal sent from the controller 11 so as to form an electrostatic latent image. The electrostatic latent image is developed by the developing unit 15, and as a result, a toner image is formed.

The above-mentioned standby rollers 24 send out one of the sheets P in such a manner that the sheet P reaches a position facing the transfer unit 16 in accordance with the timing at which a toner image formed on the photoconductor 12 reaches the position. Then, the toner image on the photoconductor 12 is transferred onto the sheet P, which has been sent out, by operation of the transfer unit 16. Accordingly, an unfixed toner image is formed on the sheet P.

The sheet P, on which the unfixed toner image has been formed, is further transported in the direction of arrow B, and the toner image is fixed onto the sheet P by being heated and pressurized by a fixing unit 18. As a result, an image, which is formed of the fixed toner image, is formed on the sheet P. The fixing unit 18 corresponds to a fixing unit according to the exemplary embodiment of the present invention.

The sheet P, which has passed through the fixing unit 18, is transported toward an ejecting unit 19 in the direction of arrow C. The sheet P is further transported by the ejecting unit 19 in the direction of arrow D and ejected to a sheet-ejection tray 20.

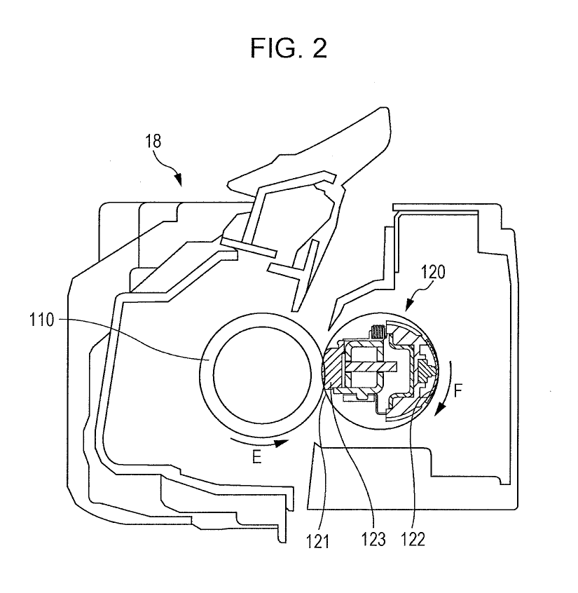

FIG. 2 is a cross-sectional view of the fixing unit 18.

The fixing unit 18 includes a pressure roller 110 and a heating roller 120. The pressure roller 110 and the heating roller 120 correspond to examples of plural contact members according to the exemplary embodiment of the present invention.

The pressure roller 110 is a roller formed by covering a metal core with a rubber and rotates in the direction of arrow E.

The heating roller 120 includes an outer circumferential belt 121. A heater 122, a pressure pad 123 and the like are accommodated in a space enclosed by the outer circumferential belt 121. The outer circumferential belt 121 corresponds to an example of a circulation member according to the exemplary embodiment of the present invention, and the heater 122 corresponds to an example of a heating element according to the exemplary embodiment of the present invention.

The outer circumferential belt 121 of the heating roller 120 is heated by the heater 122, which is in surface contact with an inner peripheral surface of the outer circumferential belt 121, and moves circularly in the direction of arrow F. The outer circumferential belt 121 is pressed against the pressure roller 110 by the pressure pad 123, and pressure and heat is applied to one of the sheets P, which is a recording medium, as a result of the sheet P passing between the outer circumferential belt 121 and the pressure roller 110.

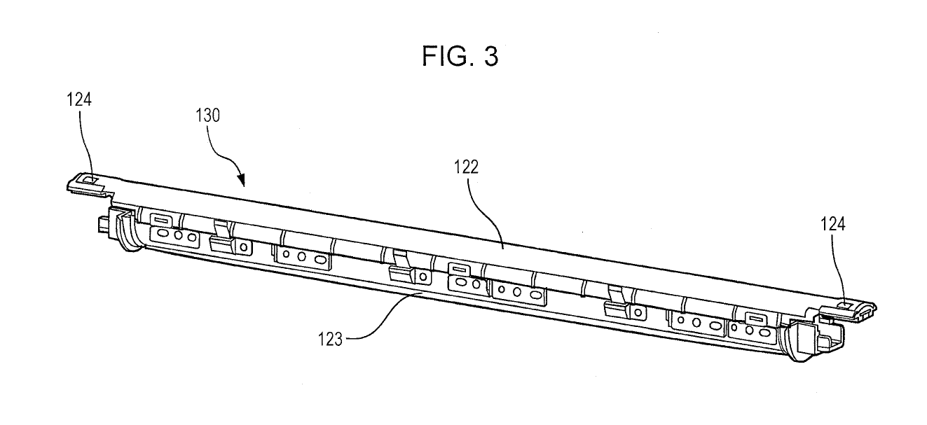

FIG. 3 is a diagram illustrating an accommodating unit that is accommodated in the heating roller 120.

An accommodating unit 130 illustrated in FIG. 3 includes the above-mentioned heater 122 and the above-mentioned pressure pad 123. The heater 122 has an elongated shape, and power-supplying electrodes 124 are disposed at ends of the heater 122 in the longitudinal direction of the heater 122. The heater 122 generates heat as a result of power being supplied thereto via the power-supplying electrodes 124. Wiring lines 132 are connected to the power-supplying electrodes 124 in order to supply power to the heater 122, and the wiring lines 132 are connected to the power-supplying electrode 124 by connectors 131, which are freely removable, in order to improve the ease of assembly and maintenance.

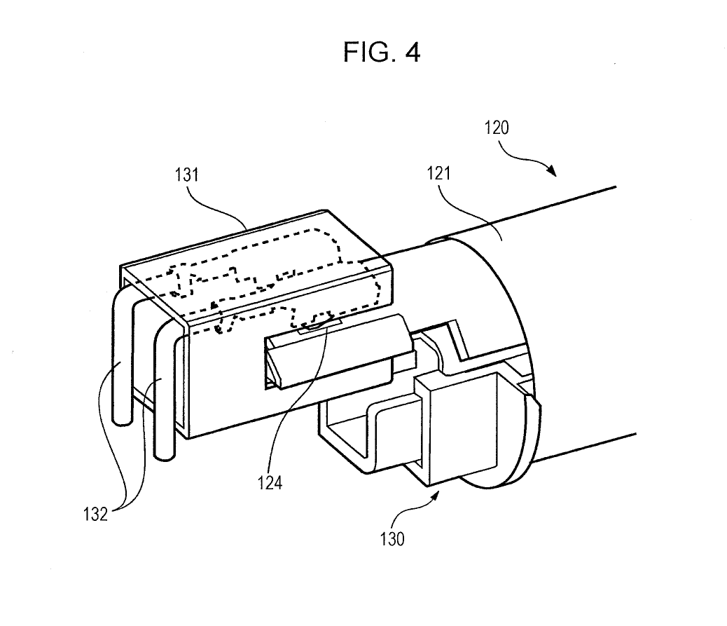

FIG. 4 is a diagram illustrating the state of a wiring connection using one of the connectors 131.

End portions of the accommodating unit 130 of the heating roller 120 project from the outer circumferential belt 121, and the above-mentioned power-supplying electrodes 124 are disposed in the projecting end portions. One of the connectors 131 is inserted so as to be engaged with one of the end portions from the left side in FIG. 4, so that the wiring lines 132, which are incorporated within the connector 131, are connected to the corresponding power-supplying electrodes 124. Although only one of the end portions of the heating roller 120 is illustrated in FIG. 4, the other one of the end portions has a similar structure, and other wiring lines 132 are connected to the corresponding power-supplying electrodes 124.

Each of the power-supplying electrodes 124 corresponds to an example of an electrode of a heating element according to the exemplary embodiment of the present invention. Each of the connectors 131 corresponds to an example of a removable member according to the exemplary embodiment of the present invention. Each of the wiring lines 132 incorporated within the corresponding connectors 131 corresponds to an example of a wiring line according to the exemplary embodiment of the present invention.

The wiring connection in the exemplary embodiment will now be described in comparison to the wiring connection in a comparative example.

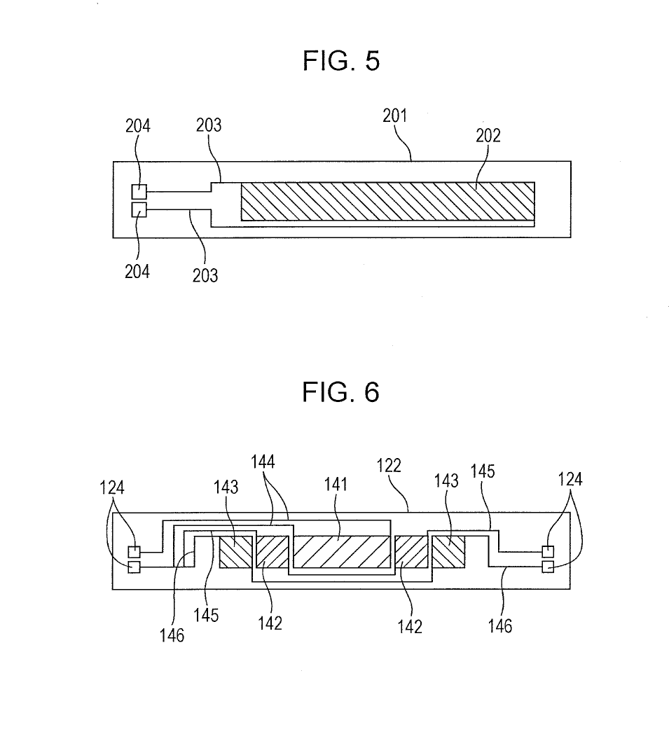

FIG. 5 is a diagram schematically illustrating a wiring structure of a heater in the comparative example, and FIG. 6 is a diagram schematically illustrating a wiring structure of the heater 122 according to the exemplary embodiment.

A heater 201 according to the comparative example includes a single heat-generating portion 202, and power-supplying wiring lines 203 are connected to ends of the heat-generating portion 202. These power-supplying wiring lines 203 are guided to one side of the heater 201, which has a long length, and are each connected to a corresponding one of two power-supplying electrodes 204. As described above, in the heater 201 according to the comparative example, the power-supplying electrodes 204 are disposed on only one side of the heater 201 in the longitudinal direction of the heater 201. Thus, by fixing a side of the heater 201 on which the power-supplying electrodes 204 are disposed onto a frame or the like and holding the other side of the heater 201 so as to enable the other side to be freely movable in the longitudinal direction of the heater 201, the positions of the power-supplying electrode 204 are fixed in place even in the case where the heater 201 thermally expands. Therefore, when external wiring lines are connected to the power-supplying electrode 204, which are fixed in place, by connectors, the positions of the power-supplying electrode 204 and the positions of the connectors remain fixed in place with respect to each other even in the case where the heater 201 thermally expands.

On the other hand, the heater 122 according to the exemplary embodiment includes three heat-generating portions 141, 142, and 143 to be compatible with sheets of different sizes. In order to supply power separately to each of these three heat-generating portions 141, 142, and 143, the heater 122 according to the exemplary embodiment includes three lines of power-supplying wiring lines 144, 145, and 146. In order to supply power separately to the each of three heat-generating portions 141, 142, and 143 via the three lines of the power-supplying wiring lines 144, 145, and 146, two of the above-described power-supplying electrodes 124 are disposed at each end portion of the heater 122, that is, there are four power-supplying electrodes 124 in total. Considering that the wiring lines 132 are connected to the corresponding power-supplying electrodes 124 by the connectors 131, in the case where a large number of electrodes are disposed on one side of the heater 122, the size of one of the connectors increases which in turn results in a lack of space, and thus, a structure, such as that illustrated in FIG. 6, in which two of the power-supplying electrodes 124 are disposed at each end portion of the heater 122 is practical.

Since the power-supplying electrodes 124 are disposed in the longitudinal direction in both of the end portions of the heater 122 according to the exemplary embodiment, it is difficult to accommodate thermal expansion of the heater 122 in a manner such as that illustrated in FIG. 5 in which thermal expansion of the heater 201 is accommodated on one side on which the power-supplying electrodes 204 are not disposed. However, in the case where deviations in the positions of the power-supplying electrodes 124 and the above-mentioned connectors 131 occur along with the thermal expansion, surfaces of the power-supplying electrodes 124 and the corresponding wiring lines 132 may be rubbed against each other so that an oxide film or the like may be formed on each of the surfaces of the power-supplying electrodes 124, and as a result, there is a possibility that a problem, such as a conduction failure, will occur. Accordingly, in the exemplary embodiment, the heater 122 is devised to avoid such deviations in the positions of the power-supplying electrodes 124 and the above-mentioned connector 131, which cause the power-supplying electrodes 124 and the corresponding wiring lines 132 to be rubbed against each other. Along with the description of this device, the accommodating unit 130, which is accommodated in the heating roller 120, will be described below.

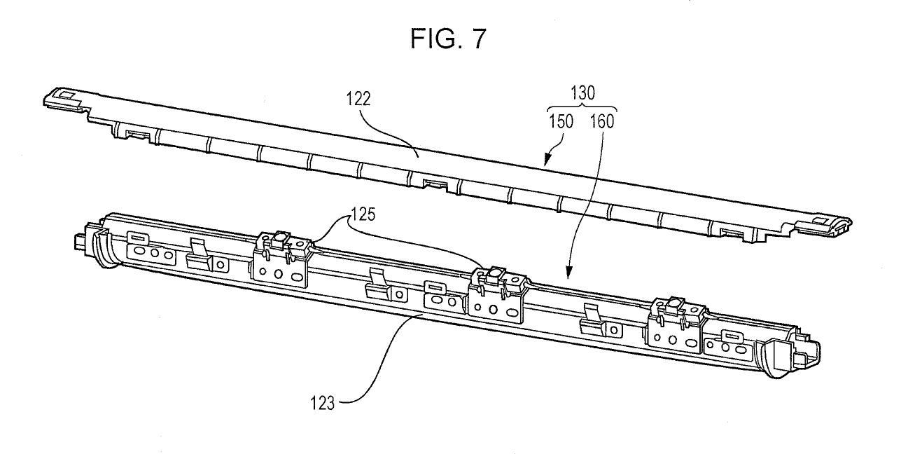

FIG. 7 is an exploded perspective view of the accommodating unit 130, which is illustrated in FIG. 3.

The accommodating unit 130, which is accommodated in the heating roller 120, is divided into a heater portion 150 and a pressing unit 160. The heater portion 150 includes the above-described heater 122 and is pressed against the inner peripheral surface of the outer circumferential belt 121 (see FIG. 2) of the heating roller 120 in a direction from the lower side toward the upper side in FIG. 7. The heater portion 150 corresponds to an example of a heater according to the exemplary embodiment of the present invention.

On the other hand, the pressing unit 160 includes the above-described pressure pad 123 and is pressed against the inner peripheral surface of the outer circumferential belt 121 in a direction from the upper side toward the lower side in FIG. 7. In addition, the pressing unit 160 includes three sensors 125 that are pressed against the inner side of a surface of the heater 122 that is in contact with the outer circumferential belt 121 and that detect a temperature of heat generated by the heater 122, and each of the three sensors 125 detects a temperature of heat generated by a corresponding one of the three heat-generating portions 141, 142, and 143 illustrated in FIG. 6.

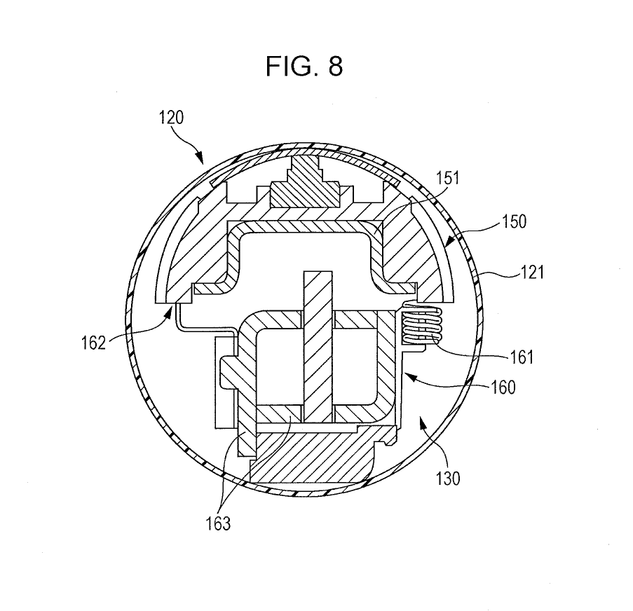

FIG. 8 is cross-sectional view of the heating roller 120.

Regarding the heater portion 150 and the pressing unit 160, which are accommodated in the space enclosed by the outer circumferential belt 121 of the heating roller 120, one end of the heater portion 150 and one end of the pressing unit 160 in the lateral direction of the heater portion 150 and the pressing unit 160 are coupled to each other via a pressing spring 161, and the other end of the heater portion 150 and the other end of the pressing unit 160 in the lateral direction are coupled to each other by a fulcrum 162. The pressing spring 161 presses the heater portion 150 and the pressing unit 160 in a direction in which the heater portion 150 and the pressing unit 160 move away from each other so that the heater portion 150 and the pressing unit 160 are pressed against the inner peripheral surface of the outer circumferential belt 121 in such a manner as to open up around the fulcrum 162.

A metallic structural member 163 incorporated within the pressing unit 160 holds the entire accommodating unit 130, and the heater portion 150 is supported by the pressing unit 160 by being coupled to the pressing unit 160 as described above. A sheet-metal support member 151 incorporated within the heater portion 150 serves as a framework of the heater portion 150.

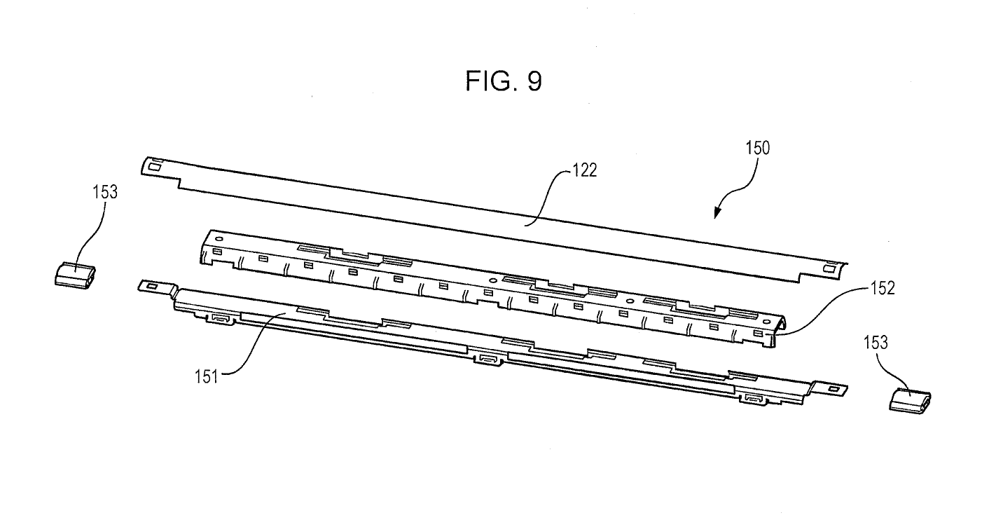

FIG. 9 is an exploded perspective view of the heater portion 150.

The heater portion 150 has a structure in which a heater guide 152, which is made of a resin, is held by the support member 151, which serves as the framework of the heater portion 150, and the heater 122 is placed on the heater guide 152. However, the heater guide 152 serves to support the heater 122 from below in FIG. 9 so as to cause the heater 122 to follow the shape of the inner peripheral surface of the outer circumferential belt 121 and does not have a function of fixing the heater 122 in place in a movement direction (process direction) of the outer circumferential belt 121 and the longitudinal direction of the heater 122. The heater 122 is fixed to the support member 151 by retainers 153, which are made of a resin and disposed at the ends of the heater 122 in the longitudinal direction of the heater 122. The retainers 153 fix the heater 122 in place in the process direction and also fix the heater 122 in place in the longitudinal direction of the heater 122 with the exception of deformation of the heater 122 as a result of thermal expansion.

Each of the retainers 153 corresponds to an example of a connecting member according to the exemplary embodiment of the present invention, and the support member 151 corresponds to an example of a support member according to the exemplary embodiment of the present invention.

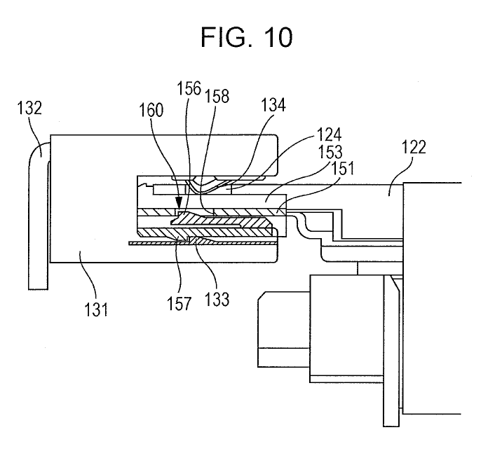

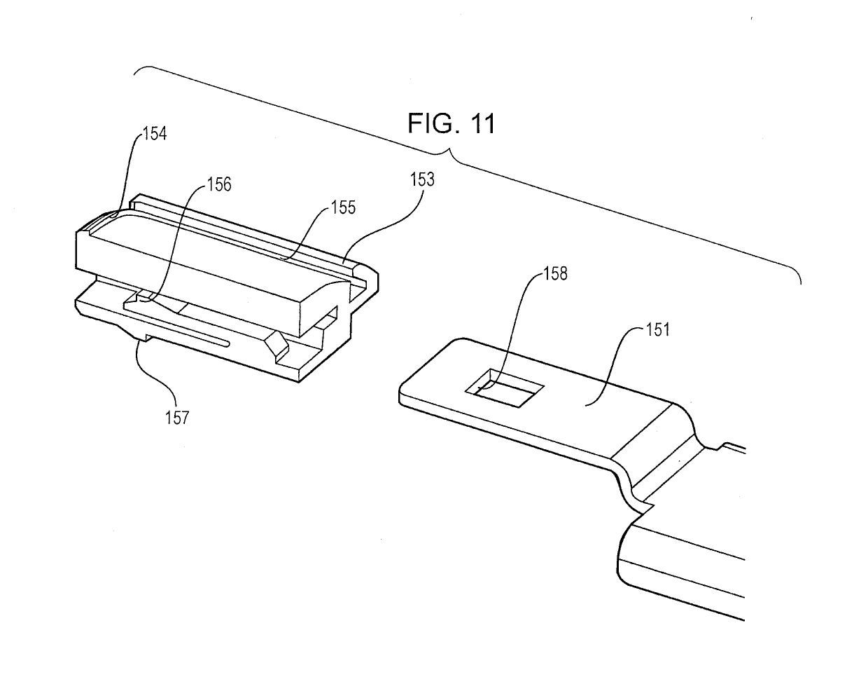

FIG. 10 is a sectional view illustrating a structure around the periphery of one of the retainers 153, and FIG. 11 is a perspective view illustrating the structure around the periphery of the retainer 153.

In FIG. 10, sectional structures of the retainer 153 and the like are illustrated as part of the side view illustrating the periphery of the retainer 153, and in FIG. 11, the retainer 153 is illustrated in a cutaway state.

The retainer 153 includes an abutting portion 154 against which an end of the heater 122 is caused to abut and a retaining groove 155 that follows the shape of the heater 122. As a result of the heater 122 being inserted so as to be engaged with the retainer 153, the retainer 153 and the heater 122 are fixed in place in a direction in which the heater 122 is inserted into and extracted from the retainers 153 and in the above-mentioned process direction by the abutting portion 154 and the retaining groove 155.

In addition, a snap fit 156 is provided in the retainer 153. When an end portion of the support member 151 is inserted into the retainer 153, the snap fit 156 is fitted into a hole 158 of the support member 151 such that the support member 151 is prevented from coming off the retainer 153, and consequently, the retainer 153 is fixed onto the support member 151. However, an accommodating margin 160 for accommodating thermal expansion is left between the hole 158 (inner wall of the hole 158) of the support member 151 and the snap fit 156, and the retainer 153 is capable of freely moving with respect to the support member 151 by an amount equal to the accommodating margin 160. Thus, when the heater 122 thermally expands, the abutting portion 154 is pressed by the end of the heater 122 so as to move in a direction in which the retainer 153 comes off the support member 151, so that the thermal expansion is accommodated. Note that, also when the heater 122 shrinks after generating heat, deformation of the heater 122 is accommodated as a result of the retainer 153 moving in a direction opposite to the direction in which the retainer 153 comes off the support member 151. Since the retainers 153 are disposed at the ends of the heater 122 in the longitudinal direction of the heater 122, deformation that occurs in the heater 122 when the heater 122 thermally expands (and shrinks) is distributed to the ends and accommodated at the ends. Thus, the accommodating amount at each end is small, and the accommodating margin 160 may be small.

A lock 157 is formed on the bottom surface of the retainer 153, and as a result of a corresponding one of the connectors 131 being inserted so as to be engaged with the retainer 153 in the longitudinal direction of the heater 122 from the left side in FIG. 10, the lock 157 engages with a protrusion 133 of the connector 131 such that the connector 131 is prevented from coming off the retainer 153. Contact points 134, which are ends of the wiring lines 132 incorporated within the connector 131, are brought into contact with the power-supplying electrodes 124 of the heater 122, and the connector 131 clamps the retainer 153 and the heater 122 by the contact pressure of each of the contact points 134. As described above, by preventing the connector 131 from coming off the retainer 153 and causing the connector 131 to clamp the retainer 153 and the heater 122, the connector 131 is fixed onto the retainer 153. As a result, even in the case where the heater 122 thermally expands, the connector 131 moves together with the retainer 153, and the contact points 134 and the corresponding power-supplying electrodes 124 remain fixed to each other. Accordingly, the occurrence of a conduction failure due to an oxide film or the like is suppressed. Note that the connector 131 is extracted from the retainer 153, and the wiring lines 132 and the corresponding power-supplying electrodes 124 are easily disconnected from each other as required, for example, in the case of maintenance. In addition, when maintenance is completed or during assembly, the wiring lines 132 and the corresponding power-supplying electrodes 124 are easily connected to each other by inserting the connector 131 into the retainer 153.

A second exemplary embodiment in which a connector structure is different from that in the first exemplary embodiment will now be described.

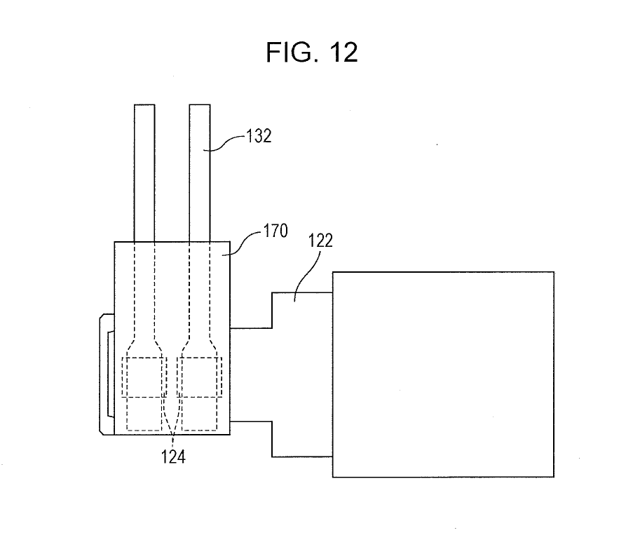

FIG. 12 is a diagram illustrating the connector structure according to the second exemplary embodiment.

In the second exemplary embodiment illustrated in FIG. 12, a connector 170 is inserted into and extracted from a retainer 153 in the above-mentioned process direction. Since the connector 170 is fixed onto the retainer 153 even though the direction in which the connector 170 is inserted into and extracted from the retainer 153 is different from the direction in which the connector 131 is inserted into and extracted from the retainer 153 in the first exemplary embodiment, when the heater 122 thermally expands, the wiring lines 132 and the corresponding power-supplying electrodes 124 remain fixed to each other.

Note that, although the heater 122, which is curved and is in contact with the inner peripheral surface of the outer circumferential belt 121, has been described in the above exemplary embodiments, the heating element according to the exemplary embodiments of the present invention may have a flat plate-like shape.

Although the case where the heating element according to the exemplary embodiments of the present invention is accommodated in the space enclosed by the outer circumferential belt 121 has been described above, the heating element according to the exemplary embodiments of the present invention may be accommodated in a metal cylinder or the like.

Although the heating roller 120 that includes the outer circumferential belt 121, which moves circularly, and the pressure roller 110 that rotates have been described above as examples of the plural contact members according to the exemplary embodiments of the present invention, the plural contact members according to the exemplary embodiments of the present invention may be rotary members that are in contact with each other or may be contact members that are in contact with each other and each of which includes a circulating belt.

Although the configuration in which the retainers 153 are disposed at the ends of the heater 122 has been described as an example, the present invention may employ a configuration in which a connecting member is disposed on only one end of the heating element in the longitudinal direction of the heating element, and the heating element and a support are fixed to each other without disposing a connecting member on the other end of the heating element.

Although a black-and-white printer has been described as an example in the above exemplary embodiments, the present invention may be applied to a color printer or may be applied to a facsimile machine, a copying machine, or a multifunction machine.

Although a device that employs an electrophotographic system and forms a toner image has been described as an example in the above exemplary embodiments, the forming unit according to the exemplary embodiments of the present invention may be a device that employs a system other than the electrophotographic system and forms a toner image on a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A heater comprising:
a heating element that includes an electrode disposed at an end of the heating element in a longitudinal direction of the heating element,
wherein the heating element is configured to generate heat as a result of power being supplied to the heating element via the electrode;
a support member that supports the heating element;
a connecting member that is disposed between the heating element and the support member,
wherein the connecting member couples the heating element and the support member to each other at the end,
wherein the connecting member is fixed to the heating element in directions including the longitudinal direction and is fixed to the support member in such a manner as to be freely movable in the longitudinal direction; and
a wiring line that is connected to the electrode of the heating element and that is fixed to the connecting member,
wherein a longitudinal end of the heating element is configured to abut against the connecting member.

2. The heater according to claim 1, further comprising:
a removable member that includes the wiring line incorporated within the removable member and that connects the wiring line and the electrode by being removably fixed to the connecting member.

3. The heater according to claim 1,
wherein the connecting member is disposed at each end of the heating element.

4. The heater according to claim 2,
wherein the connecting member is disposed at each end of the heating element.

5. A fixing unit comprising:
a plurality of contact members that have peripheral surfaces in contact with each other,
wherein the plurality of contact members is configured to fix an unfixed image onto a recording medium onto the recording medium as a result of the recording medium passing between the peripheral surfaces;
a heating element that is comprised within at least one of the plurality of contact members,
wherein the heating element includes an electrode disposed at an end of the heating element in a longitudinal direction of the heating element, and
wherein the heating element is configured to generate heat as a result of power being supplied to the heating element via the electrode;
a support member that supports the heating element;
a connecting member that is disposed between the heating element and the support member,
wherein the connecting member couples the heating element and the support member to each other at the end,
wherein the connecting member is fixed to the heating element in directions including the longitudinal direction and is fixed to the support member in such a manner as to be freely movable in the longitudinal direction; and
a wiring line that is connected to the electrode of the heating element and that is fixed to the connecting member,
wherein a longitudinal end of the heating element is configured to abut against the connecting member.

6. The heater according to claim 5,
wherein the at least one of the contact members within which the heating element is comprised includes a substantially belt-like circulation member that is disposed on a portion of the peripheral surface of the contact member and that is configured to move circularly along the peripheral surface, and
wherein the heating element is a substantially sheet-shaped heater that is in surface contact with an inner peripheral surface of the circulation member.

7. An image forming apparatus comprising:
a forming unit configured to form an unfixed image on a recording medium;
a plurality of contact members that have peripheral surfaces in contact with each other,
wherein the plurality of contact members is configured to fix the unfixed image onto the recording medium as a result of the recording medium passing between the peripheral surfaces;
a heating element comprised within at least one of the plurality of contact members,
wherein the heating element includes an electrode disposed at an end of the heating element in a longitudinal direction of the heating element,
wherein the heating element is configured to generate heat as a result of power being supplied to the heating element via the electrode;
a support member that supports the heating element;
a connecting member that is disposed between the heating element and the support member,
wherein the connecting member couples the heating element and the support member to each other at the end,
wherein the connecting member is fixed to the heating element in directions including the longitudinal direction and is fixed to the support member so as to be freely movable in the longitudinal direction;
a wiring line that is connected to the electrode of the heating element and that is fixed to the connecting member,
wherein a longitudinal end of the heating element is configured to abut against the connecting member.
